(19) United States
(12) Patent Application Publication
(10) Pub. No.: US 2012/0192605 A1
(43) Pub. Date: Aug. 2, 2012

(54) FERTILIZER COMPOSITION AND METHOD

(75) Inventors: Brian B. McSpadden Gardener, Wooster, OH (US); Sunjeong Park, Wooster, OH (US); Matthew D. Kleinhenz, Wooster, OH (US); Natalie R. Bumgarner, Wooster, OH (US)

(73) Assignee: THE OHIO STATE UNIVERSITY, Columbus, OH (US)

(21) Appl. No.: 13/334,149

(22) Filed: Dec. 22, 2011

Related U.S. Application Data
(60) Provisional application No. 61/426,755, filed on Dec. 23, 2010.

(51) Int. Cl. C05F 11/08

(52) U.S. Cl. 71/7; 71/6

(57) ABSTRACT

Embodiments relate to a composition and method for enhancing the growth of a plant using an inoculant composition comprising an effective quantity of an algal component in conjunction with a bacterial component.

### CROSS-REFERENCE TO RELATED APPLICATIONS

This non-provisional patent application claims the benefit of U.S. Provisional Application 61/426,755 filed on 23 Dec. 2010, the content of which is hereby incorporated by reference as if recited fully herein.

### TECHNICAL FIELD

Embodiments relate to compositions and methods for enhancing plant growth. More particularly, embodiments relate to inoculant compositions for enhancing plant growth comprising microorganisms and methods for using the compositions.

### BACKGROUND OF THE ART

In recent years, the use of biological agents to increase agricultural productivity and efficiency has been investigated. These studies have shown that various microorganisms are able to supplement plant growth, thus offering an attractive alternative to chemical fertilizers which are less favored because of their expense and effect on environmental quality. The mechanisms by which biological agents are able to increase agricultural productivity and efficiency are diverse, and will vary depending upon the unique characteristics of each particular agent. Because biological agents offer many potential advantages, the search continues for improved agents that enhance the growth of useful plants while reducing the need for chemical fertilizers.

### SUMMARY

Embodiments relate to a method for enhancing the growth of a plant using an inoculant composition comprising an effective quantity of an algal component in conjunction with a bacterial component. Some embodiments include a growth enhancing composition for application to plants, comprising: an algal component comprising an effective quantity of an isolated algal strain deposited as ATCC accession number PTA-11477; and a bacterial component comprising an effective quantity of an isolated bacterium. In various embodiments, the isolated bacterium is capable of living symbiotically with the algal component. In specific embodiments, the isolated bacterium is selected from the group consisting of a first isolated Microbacterium strain deposited as ATCC accession number PTA-11476, a second isolated Microbacterium strain deposited as ATCC accession number PTA-11475, and a combination thereof.

Embodiments include a method for enhancing the growth of a plant, the method comprising the step of placing in the vicinity of the plant an effective quantity of an inoculant composition, the composition comprising: an algal component comprising an effective quantity of an isolated algal strain deposited as ATCC accession number PTA-11477; and a bacterial component comprising an effective quantity of an isolated bacterium. In various embodiments, the bacterial component comprises an effective quantity of an isolated bacterium capable of living symbiotically with the algal component. In some embodiments, the isolated bacteria is selected from the group consisting of a first isolated Microbacterium strain deposited as ATCC accession number PTA-11476, a second isolated Microbacterium strain deposited as ATCC accession number PTA-11475, and a combination thereof. In various embodiments, the effective quantity of the algal strain comprises greater than about 1×10⁴ algal cells per ml or per g carrier or per seed and the effective quantity of the isolated bacteria comprises greater than about 1×10⁵ bacterial cells per ml or per g carrier or per seed. In specific embodiments, the plant is selected from the group consisting of green beans, turf grasses, sweet potato, tomatoes, cotton, corn, soy beans, okra, lettuce, tomato, squash, vegetables, tea, wheat, barley, rice, and canola.

Embodiments further include any mutants thereof which retain the ability to enhance plant growth. Exemplary embodiments also include the inoculant composition, a plant contacted with the inoculant composition, and or a seed coated with the inoculant composition.

Exemplary embodiments provide an inoculant composition effective in facilitating the germination and/or growth of plants. Specific embodiments provide a biological agent capable of improving yield while reducing or eliminating the need for certain chemical agents.

Other objects, advantages and features of the present invention will become apparent from the following specification when taken in conjunction with the accompanying claims.

### BRIEF DESCRIPTION OF THE BIOLOGICAL DEPOSITS

The various embodiments of the invention can be more fully understood from the following detailed description, biological deposits, and the accompanying sequence descriptions, which form a part of this application.

Applicants made the following biological deposits under the terms of the Budapest Treaty on the International Recognition of the Deposit of Microorganisms for the Purposes of Patent Procedure:

| | | | Identity of Highest Database | |
|---|---|---|---|---|
| Depositor | International | | Match Using BLASTN | |
| Identification | Depository | | (% identity across 760 nt of ITS | |
| Reference | Designation | Date of Deposit | or 16S sequence) | Classification |
| ABB2 | PTA-11477 | Nov. 10, 2010 | Various Chlamydomonadales | Novel species in the algal order |
| | | | strains (58-76%) | Chlamydomonadales |
| ABB3_1 | PTA-11476 | Nov. 10, 2010 | Different Microbacterium | Microbacterium sp. |
| | | | species (99%) | |
| ABB3_2 | PTA-11475 | Nov. 10, 2010 | Microbacterium hominis | Microbacterium hominis. |
| | | | (99%) | |

A culture of each of the above microbes has been deposited with the American Type Culture Collection (ATCC), 10801 University Blvd., Manassas, Va. 20110-2209 USA. The subject culture has been deposited under conditions that assure that access to the culture will be available during the pendency of this patent application to one determined by the Commissioner of Patents and Trademarks to be entitled thereto under 37 CFR 1.14 and 35 U.S.C. 122. The deposit is available as required by foreign patent laws in countries wherein counterparts of the subject application, or its progeny, are filed. However, it should be understood that the availability of a deposit does not constitute a license to practice the subject invention in derogation of patent rights granted by governmental action.

Further, the subject culture deposit will be stored and made available to the public in accord with the provisions of the Budapest Treaty for the Deposit of Microorganisms, i.e., it will be stored with all the care necessary to keep it viable and uncontaminated for a period of at least five years after the most recent request for the furnishing of a sample of the deposit, and in any case, for a period of at least 30 (thirty) years after the date of deposit or for the enforceable life of any patent which may issue disclosing the culture.

### SEQUENCE LISTING

A listing of the sequences discussed herein is contained in an ASCII text file, filed with this application, titled 20101201 Sequence project_ST25, created on 21 Dec. 2010, the content of which is hereby incorporated by reference.

### BRIEF DESCRIPTION OF THE SEQUENCES

SEQ ID NO: 1 is the 8F primer for amplification of the 16S gene for algae associated bacteria isolates.

SEQ ID NO: 2 is the 1492R primer for amplification of the 16S gene for algae associated bacteria isolates.

SEQ ID NO: 3 is the sequence of the ITS5 primer used to obtain a partial sequence of the ITS region of algae.

SEQ ID NO: 4 is the sequence of the ITS4 primer used to obtain a partial sequence of the ITS region of algae.

SEQ ID NO: 5 is a partial 16S rDNA sequence of a first bacterium (ABB3_{—}1) according to embodiments of the invention.

SEQ ID NO: 6 is a partial 16S rDNA sequence of a second bacterium (ABB3_{—}2) according to embodiments of the invention.

SEQ ID NO: 7 is a partial ITS region sequence of the algae (ABB2) according to embodiments of the invention.

### BRIEF DESCRIPTION OF THE DRAWINGS

A better understanding of the embodiments will be obtained from a reading of the following detailed description and the accompanying drawings in which:

FIG. 1 is a photomicrograph demonstrating typical aggregates of algae and bacteria found in cultures of ABB1 grown in BG-11 liquid media.

FIG. 2 shows scanning electron microscopy (SEM) images of a sand particle from non-inoculated pot (Panel A) and a sand particle from an ABB1 inoculated pot (Panel B). Comparison of the two images reveals that a mixed biofilm forms on sand particles in the ABB1 inoculated pots. Both panels are shown at 200× magnification.

FIG. 3 shows scanning electron microscopy (SEM) images of a sand particle from non-inoculated pot (Panel A) and a sand particle from an ABB1 inoculated pot (Panel B) at higher magnification. The images show the co-occurrence of algae and bacteria in the biofilm formed by the ABB1 inoculant. Panel A is shown 1000× magnification and Panel B is shown at 1800× magnification.

FIG. 4 shows a phylogenetic analysis of the algal components of the ABB biofertilizer. Phylogenetic analysis of algae indicates that the algae isolates belong to the order, Chlamydomonadales based on partial internal transcribed spacer (ITS) sequence. The sequences of representative strains in Chrolophyta are included in the dendrogram. The phylogenetic relationships among taxa were inferred from ˜750 by of ITS gene using the neighbor-joining method based on the number of differences in nucleotide. Bootstrap values of >50% (1,000 replicates) are shown.

FIG. 5 shows a phylogenetic analysis of algae associated bacteria ABB3_{—}1 and ABB3_{—}2. The sequences of the type strains in genera Microbacterium are included. The phylogenetic relationships among taxa were inferred from ˜1150 by of the 16S rRNA gene using the neighbor-joining method from distance computed with Kimura 2 parameter algorithm. Bootstrap values of >50% (1,000 replicates) are shown. The scale indicates the units of the number of base substitutions per site.

### DETAILED DESCRIPTION

Embodiments relate to a novel mixture of algal and bacterial microorganisms that enhance plant growth. A culture of each component microbe has been deposited with the American Type Culture Collection (ATCC), 10801 University Blvd., Manassas, Va. 20110-2209 USA. The component algal strain has been assigned accession number ATCC No. PTA-11477 by the repository. The bacterial component comprises an effective quantity of an isolated bacterium. In some embodiments, the bacterium is selected from the group consisting of a first isolated Microbacterium strain deposited as ATCC accession number PTA-11476, a second isolated Microbacterium strain deposited as ATCC accession number PTA-11475, and combinations thereof. All strains were deposited on Nov. 10, 2010.

Unless otherwise defined, all technical and scientific terms used herein have the same meaning as commonly understood by one of ordinary skill in the art to which these embodiments pertain. Although methods and materials similar or equivalent to those described herein can be used in the practice or testing of various embodiments, suitable methods and materials are described below. All publications, patent applications, patents, and other references mentioned herein are incorporated by reference in their entirety for all purposes. In case of conflict, the present specification, including definitions, will control. In addition, the materials, methods, and examples are illustrative only and not intended to be limiting.

The section headings used herein are for organizational purposes only and are not to be construed as limiting the described subject matter in any way. It will be appreciated that there is an implied “about” prior to metrics such as temperatures, concentrations, and times discussed in the present teachings, such that slight and insubstantial deviations are within the scope of the present teachings herein. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the invention. The articles “a” and “an” are used herein to refer to one or to more than one (i.e., to at least one) of the grammatical object of the article. By way of example, “an element” means one element or more than one element.

As used herein, reference to “isolated” means that the strain is removed from the environment in which it exists in nature. Thus, the isolated strain may exist as, for example, a biologically pure culture, dormant cells, or as spores (or other forms of the strain) in association with a carrier material.

Embodiments include an inoculant composition comprising a mixture of algal and bacterial strains that enhance plant growth. The inoculant composition of an exemplary embodiment comprises an algal component comprising an effective quantity of a novel algal strain deposited as ATCC accession number PTA-11477. The relevant alga species is believed to be previously unknown. The inoculant composition further comprises a bacterial component. The bacterial component is selected from the group of bacteria with stimulatory effects on algae, such as a first isolated Microbacterium strain deposited as ATCC accession number PTA-11476, a second isolated Microbacterium strain deposited as ATCC accession number PTA-11475, and combinations thereof. Embodiments include mutations of the component microorganisms above which retain the ability to enhance the growth of plants. As used herein, the above microorganism shall sometimes be referred to collectively as the “component microorganisms.”

In an exemplary embodiment, the inoculant composition comprises an algal component. In some embodiments, the algal component may comprise an isolated algal strain harboring an ITS gene comprising at least 95% (e.g., 96%, 97%, 98%, etc.) sequence identity to SEQ ID NO: 7 in the sequence listing. Various embodiments may also comprise a growth medium and or metabolites produced by the algal strains noted above.

In some embodiment, the inoculant composition comprises a bacterial component. The bacterial component may comprise an isolated bacterial strain harboring a 16S ribosomal RNA gene comprising at least 95% (e.g., 96%, 97%, 98%, etc.) sequence identity to SEQ ID NOS: 5 or 6 in the sequence listing. Various embodiments may also comprise a growth medium and or metabolites produced by the bacterial strains noted above.

The determination of percent identity or homology between two sequences is accomplished using the algorithm of Karlin and Altschul (1990) Proc. Nat'l Acad. Sci. USA 87: 2264-2268, modified as in Karlin and Altschul (1993) Proc. Nat'l Acad. Sci. USA 90:5873-5877. Such an algorithm is incorporated into the NBLAST of Altschul et al. (1990) J. Mol. Biol. 215:403-410. BLAST nucleotide searches are performed with the BLASTN program, to obtain nucleotide sequences homologous to the nucleic acid molecules of the invention. To obtain gapped alignments for comparison purposes, Gapped BLAST is utilized as described in Altschul et al. (1997) Nucleic Acids Res. 25: 3389-3402. For the purposes of this disclosure, determinations of percent identity are computed using the default parameters of BLASTN. See http://www.ncbi.nlm.nih.gov.

The methods and compositions should be useful for increasing growth in a wide range of plants, including, without limitation, legumes, non-legumes, cereals, oilseeds, fiber crops, starch crops, fruits, vegetables, and turf. Non-limiting examples of legumes include soybeans; peanuts; chickpeas; all the pulses, including peas and lentils; all the beans; major forage crops, such as alfalfa and clover; and many more plants of lesser agricultural importance, such as lupines, sainfoin, trefoil, and even some small tree species. Non-limiting examples of cereals include corn, wheat, barley, oats, rye and triticale. Non-limiting examples of oilseeds include canola and flax. Non-limiting examples of fiber crops include hemp and cotton. Non-limiting examples of starch crops include potato, sugar cane and sugar beets. Non-limiting examples of vegetables include carrots, radishes, cauliflower, broccoli, peppers, lettuce, cabbage, tomato, peppers, celery and Brussels sprouts.

Techniques for applying inoculant compositions to plants are known in the art, including appropriate modes of administration, frequency of administration, dosages, et cetera. Typically, inoculants are in a liquid or powdered form. Suitable auxiliaries, such as carriers, diluents, excipients, and adjuvants are known in the art. For example, dry or semi-dry powdered inoculants often comprise the microorganism(s) of interested dispersed on powdered peat, clay, other plant material, or a protein such as casein. The inoculant may include or be applied in concert with other standard agricultural auxiliaries such as fertilizers, pesticides, or other beneficial microorganisms.

The inoculant compositions may be applied to the soil prior to, contemporaneously with, or after sowing seeds, after planting, or after plants have emerged from the ground. The inoculant may also be applied to seeds themselves prior to or at the time of planting (e.g. packaged seed may be sold with the inoculant already applied). The inoculant may also be applied to the plant after it has emerged from the ground, or to the leaves, stems, roots, or other parts of the plant.

In various embodiments, inoculant compositions may contain only one plant growth promoting algal strain in conjunction with one or more bacterial strains. In alternative embodiments, additional strains of other beneficial microorganisms may also be present.

Kits containing the inoculant composition, or components thereof, will typically include one or more containers, and printed instructions for using the inoculant for promoting plant growth. These instructions may be printed and/or may be supplied, without limitation, as an electronic-readable medium, such as a floppy disc, a CD-ROM, a DVD, a Zip disc, a video cassette, an audiotape, and a flash memory device. Alternatively, instructions may be published on an internet web site or may be distributed to the user as an electronic mail. The kit may also include tools or instruments for reconstituting, measuring, mixing, or applying the inoculant, and will vary in accordance with the particular formulation and intended use of the inoculant. When a kit is supplied, the different components can be packaged in separate containers. Such packaging of the components separately can permit long term storage without losing the active components' functions.

It is anticipated that certain mutants of a component microorganism may also enhance plant growth comparable to the non-mutated forms set forth above. Mutants of the component microorganism may include both naturally occurring and artificially induced mutants. Certain mutants may be induced by subjecting a component microorganism to known mutagens, such as N-methyl-nitrosoguanidine, using conventional methods.

A plant enhancement assay may be performed whereby the component microorganisms, or the like, may be tested for its ability to enhance the growth of a relevant plant. The seed or seedling of the plant to be enhanced is planted in a planting medium and watered with a nutrient solution. The planting medium may be a damp soil, vermiculite in water, an agar-based formulation, or any other planting medium in which the seed or seedling will grow and develop. The inoculant composition is placed at least in the immediate vicinity of the seed or seedling. Such placement shall be understood to be in the “immediate vicinity” of the seed or seedling if the microorganisms or any soluble exudate of the microorganisms being tested will be in actual contact with the germinating seedling. After a time sufficient for seedling growth, seedlings developing from the planted seed may be evaluated for visual evidence of enhanced growth when compared to controls.

The biological inoculants of exemplary embodiments act through an unknown mechanism to enhance plant growth. While the mechanism by which these inoculants enhance plant growth is not understood, and without limitation to any theory, it is plausible that the mechanism involves enhancing the bioavailability of fixed nitrogen or other soil nutrients to the plant, or direct alteration of plant growth or physiology caused by phytohormone—like secretions of the algae in combination with the bacteria. Another possibility is that the component microorganisms have an antagonistic action on other organisms that inhibit and/or retard the germination and growth of the plant seedling. The method of action may alternatively involve a symbiotic relationship of some unknown type.

It is broadly intended that the inoculant compositions of various embodiments be inoculated into the soil with plant seeds so that a culture of the component microorganisms may develop in the root system of the plant as it grows. Alternatively, the microorganism mixture may be applied to a plant at a later vegetative stage. To facilitate this co-culturing, in some embodiments the inoculant, which may be diluted with a suitable extender or carrier, may be applied to the seeds prior to planting or introduced into the seed furrows when the seeds are planted. The biological inoculants so delivered may be any viable culture capable of successful propagation in the soil.

In at least one embodiment, the inoculant composition may be applied to the seeds through the use of a suitable coating mechanism or binder prior to the seeds being sold into commerce for planting. The process of coating seed with such an inoculum is generally well known to those skilled in the art.

Alternatively, the biological inoculant may be prepared with or without a carrier and sold as a separate inoculant to be inserted directly into the furrows into which the seed is planted. The process for inserting such inoculants directly into the furrows during seed planting is also generally well known in the art.

Each of the component microorganisms may be obtained in a substantially pure culture. A “substantially pure” culture shall be deemed to include a culture of algae or bacteria containing no other algal or bacterial species in quantities sufficient to interfere with the replication of the culture or be detected by normal techniques.

Whether the biological inoculants are contacted directly to the plant, coated directly on the seed, or inserted into the furrows, the component microorganisms may be diluted with a suitable carrier or extender so as to make the culture easier to handle and to provide a sufficient quantity of material so as allow easy human handling. It is anticipated that many other non-toxic and biologically inert substances of dried or granular nature should also be capable of serving as carriers for the component microorganisms.

The density of inoculation of these microorganisms onto seed, into the furrows, or directly upon the vegetation should be sufficient to enhance growth of the plant. In some embodiments, the microorganisms will populate the sub-soil region adjacent to the roots of the plant with viable growth. An effective amount of inoculant should be used. An effective amount is that amount sufficient to establish sufficient microorganism growth so that the yield from the plant is increased.

It has been discovered here that the inoculation of various plants with the component microorganisms results in significantly improved growth of the plants. As will be appreciated by any person skilled in plant husbandry, the rate of growth or improvement in growth of any given crop is subject to many variables. It has been found here, however, that the co-cultivation of the biological inoculant of various embodiments with a wide variety of plants is of significant advantage. It is believed that this co-cultivation technique will result generally in improved yield and improved growth of plants in field applications. It is also anticipated that the inoculation of various plants with the component microorganisms may result in significantly improved growth of those plants.

It will be appreciated by one skilled in the art that a biological inoculant of the type described herein offers several significant potential advantages over the chemical inoculants or growth hormones or similar agents commonly used in agriculture today. By the very nature of a biological inoculant, the component microorganisms are self-sustaining in a continuous fashion once they are introduced into the furrows with the plant seed. Therefore, retreatment of the plants during the crop season may be unnecessary. The microorganisms grow in cultivation along with the plants and should continue to exhibit its beneficial effect on the plant throughout the agricultural season. This is in strong contrast to chemical growth agents which must be retreated periodically to help improve the plant growth throughout its life cycle. Since the inoculant strains of various embodiments can be inoculated onto the seeds using a dry or wet formulation, the application of this technique is relatively simple to the farmer since the seeds can be inoculated prior to distribution. In this way, a significant economic advantage is achievable.

The following non-limited examples are intended to illustrate the present invention.

### EXAMPLES

The following non-limiting examples are included to demonstrate various embodiments. It should be appreciated by those skilled in the art that the techniques disclosed in the examples which follow represent techniques discovered by the inventors to function well in practice. However, those of skill in the art should, in light of the present disclosure, appreciate that many changes can be made in the specific embodiments which are disclosed and still obtain a like or similar result without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention.

### Example 1

### Recovery and Reconstruction of a Biological Biofertilizer

The components of a biological fertilizer were recovered from a non-related field fertility experiment at the Ohio Agricultural Research and Development Center (OARDC) in Wooster, Ohio. During that experiment, it was noted that lettuce growing in a nitrogen-free hydroponics mix (K: 147 ppm, P: 43 ppm, S: 81 ppm, Mg: 30 ppm, Ca; 6 ppm), unexpectedly yielded just <85% of that grown in media with sufficient N (20-160 PPM provided continuously through fertigation) (data not shown). This pattern was observed with and without supplemental heating, indicating that the microbial mix selected may be active across varied environmental conditions.

Multiple algal and prokaryotic microorganisms were recovered from the field plots described above. Briefly, two grams of soil media were added to 10 ml of sterile distilled water. Cells were dislodged from the soil by vortexing (four consecutive 15 sec. vortexing) and sonication 1 min followed by another 15 sec vortexing. 10 μl of the soil wash was plated on BG-11 amended with 10 g of agar per liter. The plates were incubated at 25° C., 100% relative humidity, under fluorescent light (˜100 μmol m⁻² s⁻¹) with 12:12 hr light:dark cycle. Algal colonies were observed from the first streak location on fifth day of incubation. In order to determine if mixes of these isolated microbes could promote plant growth, combinations of components were cultured and reintroduced as a microbial inoculant into a controlled experiment.

Initially, a mixed algae culture was prepared by combining four of the original isolates in equal proportion and its effect on lettuce growth was tested. Each isolate was grown in liquid BG-11 and cells were harvested by centrifuging for 8 min at 8000 rpm. Algal cells were re-suspended in sterile distilled water, and then four isolates were mixed. The mixed algae inoculants were trenched to pre-wetted pots seeded with lettuce at either seeding or vegetative stage (2-3 true leaves present). A total of 40 ml mixed algal culture was applied resulting in 10⁷ cells/pot inoculation rate. Four weeks after the inoculation, lettuce shoot biomass was measured (Table 1).

TABLE 1
Effects of the ABB mix 1 on lettuce cv. Outredeous

| | Fertilizer N rate | Biofertilizer | Shoot biomass |
|---|---|---|---|
| Application Time | (PPM) | Inoculation | (g FW) |
| Seeding | 0 | − | 0.73 b |
| | 0 | + | 1.22 a |
| | | | P = 0.005 |
| | 20 | − | 16.8 a |
| | 20 | + | 17.1 a |
| | | | P = 0.441 |
| Vegetative (V2) | 0 | − | 0.71 b |
| | 0 | + | 1.99 a |
| | | | P = 0.005 |
| | 20 | − | 14.5 a |
| | 20 | + | 24.5 a |
| | | | P = 0.136 |

^{a}Biofertilizer preparations were generated by culturing isolates in liquid BG-11 media at 25° C. under full fluorescent light for about 36 hours (10⁶ cells/ml). The cultured cells were separated from BG-11 media using centrifuge and re-suspended in distilled water.
^{b}Values followed by different letters are significantly different by Mood's median test. The P-value obtained for this comparison is listed below each pair of values.

In addition, lettuce roots were harvested and root cell wash was prepared by vortexing and sonication followed by another 15 sec. vortexing. The root wash suspension was plated on BG-11, then algal colonies were re-streaked on 1/10 TSA plates to isolate associated bacteria.

Preliminary sequencing data indicated the presence of a mixed culture in the isolates. To identify bacterial components, algal cells from BG-11 plate were plated on 1/10 strength of Tryptic Soy Agar (TSA). The plates were incubated at room temperature in the dark. After 3 days of incubation, different bacterial colonies were selected based on their morphology, resuspended in 1/10 TSB (tryptic soy broth) media and stored at −80° C. in 35% glycerol.

In and effort to obtain a pure algal culture, algae were plated on BG-11 agar containing streptomycin (50 ug/ml). After five days of incubation, colonies were re-streaked on 1/10 of TSA plates to confirm that the isolates were free of bacterial contamination. Growth of alga on streptomycin amended BG-11 was slower compared to non-amended BG-11 agar. When tested viability of the alga culture two weeks after culturing on streptomycin plate, the alga was not viable. To maintain the culture, alga was grown on streptomycin amended BG-11 for five days, then transferred to non amended BG-11 agar plate. These data indicate that streptomycin-sensitive bacterial symbionts stimulate the growth and/or activities of the algae strain ABB2.

### Example 2

### Microscopic Examination

For epifluorescence microscopy, 5-7 days grown algal cells from BG-11 plate were re-suspended in 200 μl of liquid BG-11 media and incubated overnight under the condition described above. The algal cells were examined with an epifluorescence inverted Leica DM IRB microscope (Leica Microsystems GmbH, Germany) equipped with Q Imaging Retiga 2000 cooled digital camera (Q Imaging, Canada).

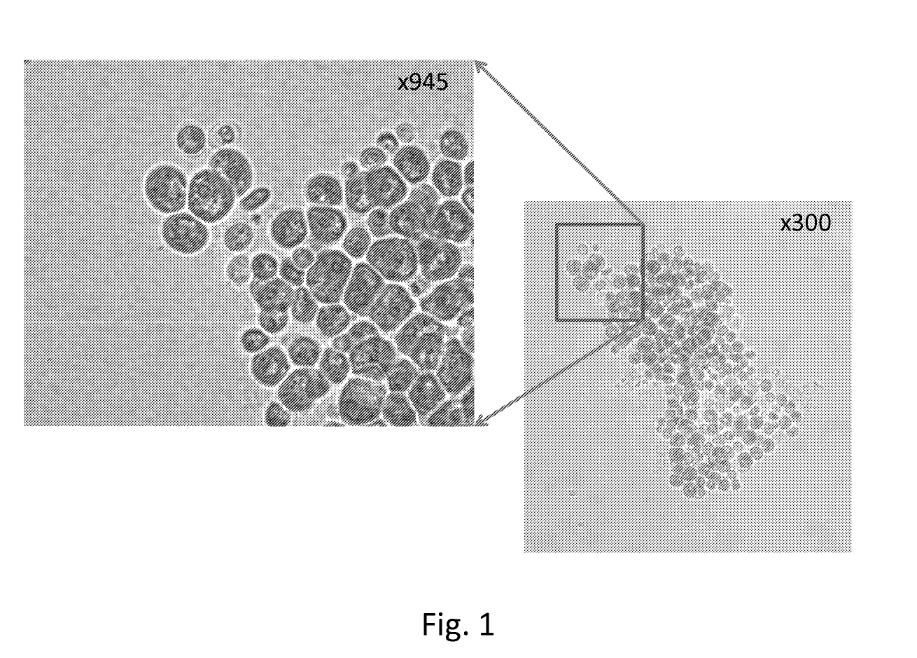

FIG. 1 is a fluorescence photomicrograph of a culture of ABB1 containing both the algae and bacteria. The algal strain is unicellular with a tendency to form aggregates under these growing conditions.

For scanning electron microscopy (SEM), samples were collected from first inoculation test pots (no inoculation, ABB1 and ABB4 treated pots). The SEM samples were fixed for a week at 4° C. in 0.1M potassium phosphate buffer with 3% glutaraldehyde and 2% paraformaldehyde. The samples were rinsed and dehydrated in ethanol. Then the samples were critical-point dried, sputter coated with platinum, and examined with Hitachi S-3500N scanning electron microscope (Hitachi High Technologies America, Inc., Schaumburg, Ill.).

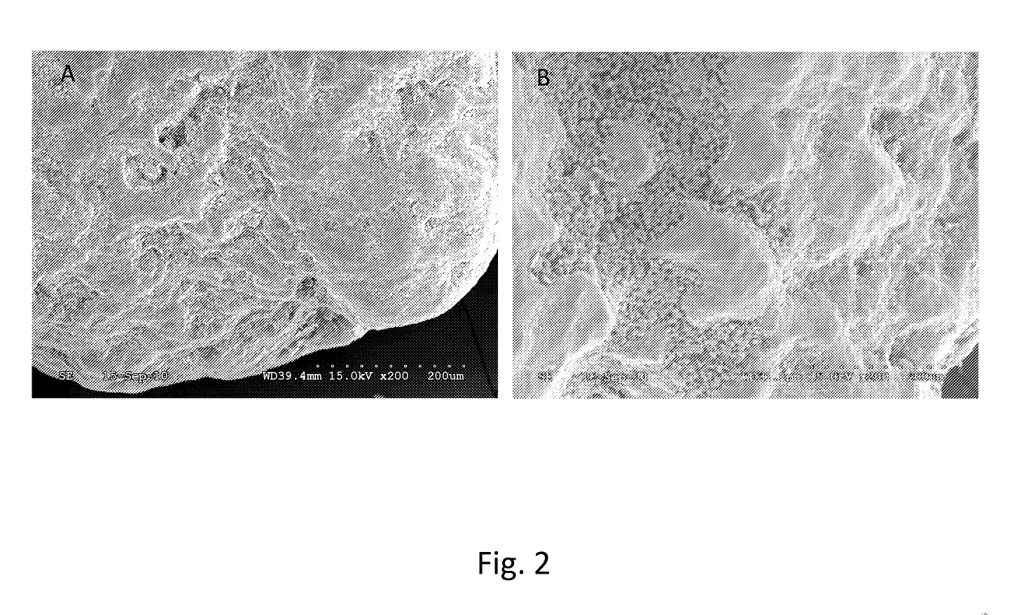

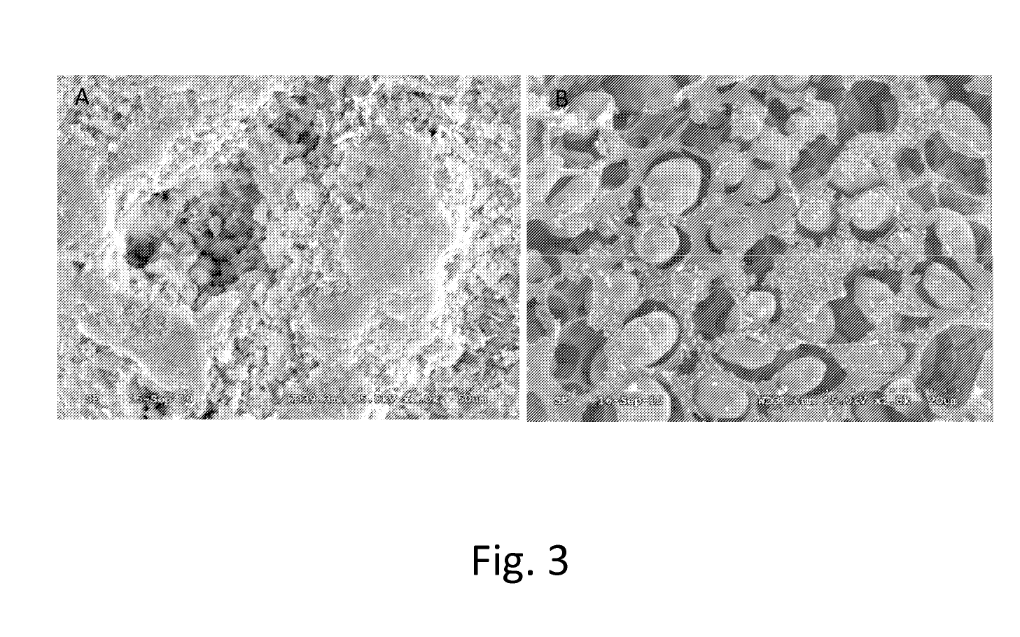

FIGS. 2 and 3 show photomicrographs comparing growth matrix from uninoculated pots (panel A) with that from pots inoculated with ABB1 (panel B). In both figures, panel B shows a biofilm containing both algae and bacteria, demonstrating their symbiosis. In contrast, panel A shows the absence of algal or bacterial cells on the surface of sand particle from non-inoculated samples. These data were obtained from sand particles from a pot treated with the inoculant composition of an exemplary embodiment.

### Example 3

### Sequence-Based Identification of Algae and Algae-Associated Bacteria Isolates

Both algae and bacterial cells were lysed using freezing at −80° C. for at least 2 hours then thawing at 65° C. for 15 min. Lysed cell mix was used as PCR template. Amplification of the 16S gene for algae associated bacteria isolates was performed with the 8F (5′ AGA GTT TGA TCC TGG CTC AG 3′ and 1492R (5′ ACG GCT ACC TTG TTA CGA CTT 3′) primers, based on those described by Weisburg et al. (1991; fD1 and rP2). Amplification of the ITS region of algae was performed with the ITS5 (5′ GGA AGT AAA AGT CGT AAC AAG G 3′) and ITS4 (5′ TCC TCC GCT TAT TGA TAT GC 3′) forward and reverse primers, respectively, based on those described by White et al. (1990). Both 16S and ITS PCR reactions were carried out in 25 μl reactions containing 1× Mg-free buffer (Promega Corp.), 1.8 mM MgCl₂, 0.2 mM deoxynucleoside triphosphates, (Sigma, Molecular Biology Reagent), 0.8 pmol each primer, 0.04 mg RNAse A, 0.06 U GoTaq DNA polymerase (Promega), and 2.5 μl template. All the amplification was performed with a PTC-200 Thermocycler (MJ Research Inc.). The cycling program for 16S gene consisted of a 5 min initial denaturation step at 95° C. followed by 30 cycles of 94° C. for 60 sec, 54° C. for 45 s, and 70° C. for 60 s; and an 8 min final extension step at 70° C. The program for ITS consisted of a 5 min initial denaturation step at 95° C. followed by 32 cycles of 94° C. for 60 s, 52° C. for 45 s, and 70° C. for 2 min; and an 8 min final extension step at 70° C. For sequencing, the amplicons were purified with ExoSAP-IT (USB, Cleveland, Ohio); 2 ul of ExoSap was added to 5 ul of PCR reaction, then incubate at 37° C. for 15 min followed by 15 min enzyme inactivation at 80° C. All the sequencing was performed at the Molecular and Cellular Imagine Center (OARDC, Wooster, Ohio) using an ABI Prism 3100×1 genetic analyzer system using 3′-BigDye dideoxynucleoside triphosphate-labeling chemistry.

The following sequences were obtained:

SEQ ID NO: 5 is the partial 16S rDNA sequence of the first bacterium (ABB3_{—}1) is SEQ ID NO:5.

SEQ ID NO: 6 is the partial 16S rDNA sequence of the second bacterium (ABB3_{—}2)

SEQ ID NO: 7 is a partial ITS region sequence of the algae (ABB2).

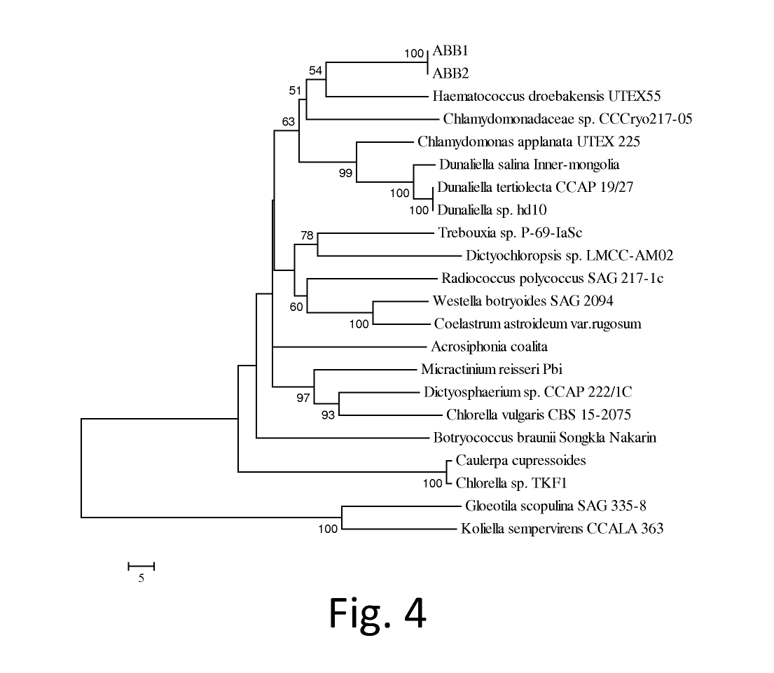

Based on the sequence data, FIG. 4 shows a phylogenetic analysis of the algal components of the ABB biofertilizer. Phylogenetic analysis of algae indicates that the algae isolates belong to a distinct and apparently novel species of the order, Chlamydomonadales based on partial internal transcribed spacer (ITS) sequence. The sequences of representative strains in Chrolophyta are included in the dendrogram. The phylogenetic relationships among taxa were inferred from ˜750 by of ITS gene using the neighbor-joining method based on the number of differences in nucleotide. Bootstrap values of >50% (1,000 replicates) are shown.

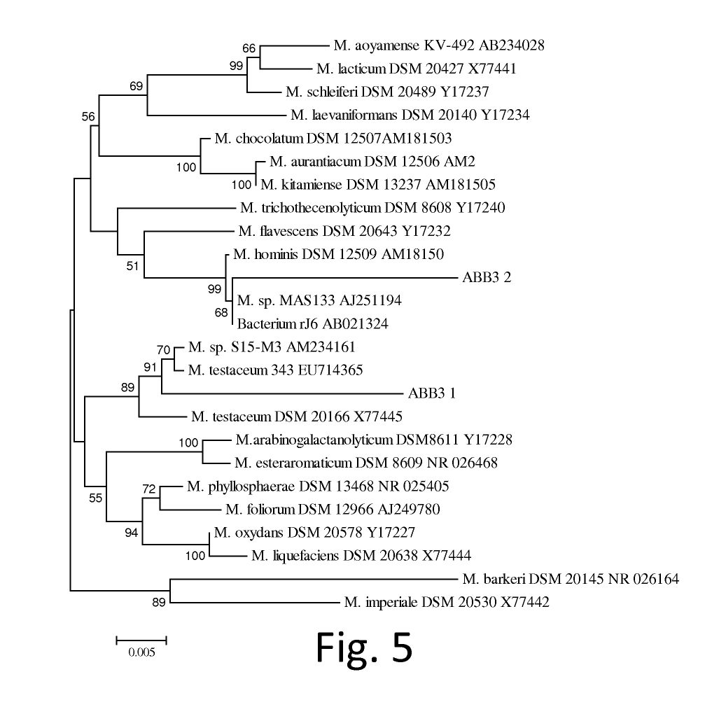

FIG. 5 shows a phylogenetic analysis of algae associated bacteria ABB3_{—}1 and ABB3_{—}2. The sequences of the type strains in genera Microbacterium are included. The phylogenetic relationships among taxa were inferred from ˜1150 by of the 16S rRNA gene using the neighbor-joining method from distance computed with Kimura 2 parameter algorithm. Bootstrap values of >50% (1,000 replicates) are shown. The scale indicates the units of the number of base substitutions per site.

In summary, potential components of algae based biofertilizer (ABB) were identified from a preliminary inoculation test on lettuce. Inoculation of the mixed culture of algae and bacteria resulted in 1.5-2 fold increase in lettuce shoot biomass without any added nitrogen. When lettuce root wash from inoculated pots was cultured on BG-11, one alga was present indicating colonization of the alga in the soil media or potentially on lettuce root. The original alga isolate that matched with root wash alga isolate is called ABB1 and the root wash alga isolate as ABB2. ABB1 and ABB2 cultures were maintained in different manner to sustain the associated bacteria component. For ABB1, subcultures were made from scrapings of algal cells from the first streak location to maintain the bacterial components. Whereas ABB2 subcultures were made from a single colony to keep a relatively clean algal culture. Similarly, when sequences of bacteria associated with the original algae and with the root wash isolated algae were compared, two bacteria were found in both collections (ABB3_{—}1 and ABB3_{—}2). Both were isolated from cultures of ABB1.

### Example 4

### Evaluation of Algal and Bacterial Components of the Biofertilizer

The following experiment was performed to determine the relative contribution of various component microorganisms of the biofertilizer. Lettuce cv. Outredgeous (Johnny's selected seeds), tomato v. Celebrity (Johnny's selected seeds), and Kentucky blue grass blends (Pennington seeds, Greenfield, Mo.) were seeded in 0.1 ft² pots filled with sand and soil conditioning clay mix (Turface professional soil conditioner, Profile soil product LLC). Prior to seeding, half set of pots received base fertilizer solution either a nitrogen-free hydroponics mix or 10 ppm nitrogen mix for three days. Both fertilizer solution contained same amount of macro nutrients (K: 147 ppm, P: 43 ppm, S: 81 ppm, Mg: 30 ppm, Ca; 6 ppm). After seeding, plants were irrigated with the same fertilizer solution at 50 ml/pot rate every other day. Inoculants and other treatments were applied when the plants reached vegetative stage (2-3 true leaves present). The applied treatments were 1) ABB1, original algal isolate containing its bacteria, 2) ABB2, algal isolate from lettuce root wash collection from preliminary inoculation test, 3) ABB3, the two Microbacterium isolates identified from lettuce root wash collection, 4) ABB4, combination of ABB2 and ABB3, 5) negative control, water and 6) positive control, chemical fertilizer solution containing 20 ppm N. For ABB1 and ABB2 treatments, algae were applied at 10⁷ cells/pot. For ABB3, mixed bacteria culture was inoculated at 10⁸ cells/pot rate. Finally, for ABB4 treatment each pot received 10⁷ algal cells and 10⁸ bacteria cells. There were four replicated pots for each treatment. The plants were grown in growth chamber (25° C., 12/12 hr light and dark cycle, 85% relative humidity). After 6 weeks from the seeding, fresh and dry shoot biomass was recorded. Oven dried leaf tissue was sent to Service Testing And Research Laboratory (OARDC, Wooster, Ohio) for total nitrogen content (combustion, AOAC Official Methods of Analysis, 2002) and major elements (microwave digestion followed by inductively coupled plasma emission spectrometry, Jones et al., 1991; Isaac and Johnson, 1985).

Table 2, 3, and 4 present results demonstrating the growth enhancing effect of the biofertilizer treatments on lettuce, tomato, and turf, respectively.

Algae in combination of bacteria (ABB1 and ABB4) improved seedling growth of tested plants. of lettuce, tomato and turf regardless of the level of initially added nitrogen (Comparisons to NC in Tables 2, 3, and 4 below). These data indicate that a combination of the deposited strains can act as an effective algae-based biofertilizer on multiple plant species. This was true when plants were watered only with water (0 PPM N) or an initial volume of 10 PPM N provided as ammonium nitrate, which can be readily assimilated by plant seedlings.

A similar plant growth effect of lower magnitude was observable when the algae (ABB2) was added alone (Comparisons to NC in Tables 2, 3, and 4 below). However, interactions with native root-colonizing bacteria and/or low-levels of cross-contamination during the growth period may have contributed to the creation of an effective algal-bacterial symbiosis with similar effects as those generated with ABB1 and ABB4.

The bacteria alone (ABB3) did not significantly enhance seedling growth in any of the experiments; further indicating the essential contribution of the algal component of the biofertilizer mixture (Comparisons to NC in Tables 2, 3, and 4 below).

The algal biofertilizer treatments ABB1, ABB2, and ABB4 promoted biomass accumulations that were comparable to regular watering with 20 PPM of N provided as ammonium nitrate in about ¼ of the experiments (Comparisons to CNF in Tables 2, 3, and 4 below). In contrast the bacteria alone, ABB3, never provided comparable levels of biomass, again indicating that importance of the algal component to the biofertilizer effect.

In total, these data indicate that the biofertilizer effect is dependent on a mixture of an algae (ABB2) and associated stimulatory bacteria (such as, but not limited to, strains ABB3_{—}1 and ABB3_{—}2).

TABLE 2
Effect of ABB biofertilizer treatments on lettuce shoot biomass.

| | | | | | |
|---|---|---|---|---|---|
| | | | Fresh shoot | P-value | P-value |
| | Base | | biomass (per | Com- | Com- |
| | Nitrogen | | seedling, g), | parison | parison |
| Crop | fertility | Treatment^{a} | Median | with NC^{b} | with CNF^{b} |

Exp. 01

| | | | | | |
|---|---|---|---|---|---|
| Lettuce | 0 ppm | NC (water) | 0.04 b | — | — |
| | | ABB1 | 0.16 a x | 0.03 | ns |
| | | ABB2 | 0.14 a x | 0.03 | 0.06 |
| | | ABB3 | 0.04 b y | ns | 0.03 |
| | | ABB4 | 0.09 a y | 0.03 | 0.03 |
| | | CNF | 0.19 x | — | — |
| | 10 ppm | NC (water) | 0.28 b | — | — |
| | | ABB1 | 0.40 a y | 0.03 | ns |
| | | ABB2 | 0.38 a x | 0.06 | 0.06 |
| | | ABB3 | 0.29 b y | ns | 0.03 |
| | | ABB4 | 0.45 a x | 0.03 | ns |
| | | CNF | 0.44 x | — | — |

Exp. 02

| | | | | | |
|---|---|---|---|---|---|
| Lettuce | 0 ppm | NC (water) | 0.04 b | — | — |
| | | ABB1 | 0.05 b y | ns | 0.03 |
| | | ABB2 | 0.09 a y | 0.03 | 0.03 |
| | | ABB3 | 0.03 b y | ns | 0.03 |
| | | ABB4 | 0.11 a y | 0.03 | 0.03 |
| | | CNF | 0.35 x | — | — |
| | 10 ppm | NC (water) | 0.57 b | — | — |
| | | ABB1 | 0.79 b y | ns | 0.03 |
| | | ABB2 | 0.62 b y | ns | 0.03 |
| | | ABB3 | 0.56 b y | ns | 0.03 |
| | | ABB4 | 0.84 a y | 0.03 | 0.06 |
| | | CNF | 1.21 x | — | — |

^{a}NC: negative control, sterile distilled water, ABB1: original algae isolate containing bacterial component (10\hat{ }7 algal cells + unknown quantity of bacterial cells), ABB2: algae isolate from lettuce root wash prepared from the preliminary inoculation test (10\hat{ }7 algal cells), ABB3: algae associated bacteria culture, contain two bacteria (ABB3_1 and ABB3_2, 10\hat{ }8 bacterial cells), ABB4: combination of ABB2 and ABB3 (10\hat{ }7 algal cells + 10\hat{ }8 bacterial cells), and CNF: chemical N fertilizer contains 20 ppm N started application at the same time of the inoculation and continued till the completion of the experiment
^{b}Pairwise comparisons between treatments and controls were performed using Mann-Whitney test. Different letters indicate significant differences (a, b: comparison with negative control (water) treatment, x, comparisonwith positive control (chemical N fertilizer treatment), P < 0.10).

TABLE 3
Effect of ABB biofertilizer treatments on tomato shoot biomass

| | | | | | |
|---|---|---|---|---|---|
| | | | Fresh shoot | P-value | P-value |
| | Base | | biomass (per | Com- | Com- |
| | Nitrogen | | seedling, g), | parison | parison |
| Crop | fertility | Treatment^{a} | Median | with NC^{b} | with CNF^{b} |

Exp. 01

| | | | | | |
|---|---|---|---|---|---|
| Tomato | 0 ppm | NC | 0.10 b | — | — |
| | | ABB1 | 0.48 a x | 0.03 | ns |
| | | ABB2 | 0.40 a x | 0.03 | ns |
| | | ABB3 | 0.12 b y | 0.06 | 0.03 |
| | | ABB4 | 0.29 a y | 0.03 | 0.03 |
| | | CNF | 0.49 x | — | — |
| | 10 ppm | NC | 0.99 b | — | — |
| | | ABB1 | 1.25 b y | ns | 0.06 |
| | | ABB2 | 1.20 b x | ns | ns |
| | | ABB3 | 0.97 b y | ns | 0.03 |
| | | ABB4 | 1.73 a x | 0.03 | ns |
| | | CNF | 1.62 x | — | — |

Exp. 02

| | | | | | |
|---|---|---|---|---|---|
| Tomato | 0 ppm | NC | 0.09 b | — | — |
| | | ABB1 | 0.23 a y | 0.03 | 0.03 |
| | | ABB2 | 0.22 a y | 0.03 | 0.03 |
| | | ABB3 | 0.11 b y | ns | 0.03 |
| | | ABB4 | 0.26 a y | 0.03 | 0.03 |
| | | CNF | 1.02 x | — | — |
| | 10 ppm | NC | 1.08 b | — | — |
| | | ABB1 | 0.95 b y | ns | 0.03 |
| | | ABB2 | 1.02 b y | ns | 0.03 |
| | | ABB3 | 0.95 b y | ns | 0.03 |
| | | ABB4 | 0.82 b y | ns | 0.03 |
| | | CNF | 1.50 x | — | — |

^{a}NC: negative control, sterile distilled water, ABB1: original algae isolate containing bacterial component (10\hat{ }7 algal cells + unknown quantity of bacterial cells), ABB2: algae isolate from lettuce root wash prepared from the preliminary inoculation test (10\hat{ }7 algal cells), ABB3: algae associated bacteria culture, contain two bacteria (ABB3_1 and ABB3_2, 10\hat{ }8 bacterial cells), ABB4: combination of ABB2 and ABB3 (10\hat{ }7 algal cells + 10\hat{ }8 bacterial cells), and CNF: chemical N fertilizer contains 20 ppm N started application at the same time of the inoculation and continued till the completion of the experiment
^{b}Pairwise comparisons between treatments and controls were performed using Mann-Whitney test. Different letters indicate significant differences (a, b: comparison with negative control (water) treatment, x, comparison with positive control (chemical N fertilizer treatment), P < 0.10).

TABLE 4
Effect of ABB biofertilizer treatments on turf biomass

| | | | Shoot | P-value | P-value |
|---|---|---|---|---|---|
| | Base N | | biomass (g, | comparison | comparison |
| Crop | fertility | Treatment^{a} | fw, median) | with NC | with CNF |
| Turf | 0 ppm | NC | 1.34 b | — | — |
| | | ABB1 | 1.89 a y | 0.03 | 0.03 |
| | | ABB2 | 1.75 a y | 0.03 | 0.03 |
| | | ABB3 | 1.40 b y | ns | 0.03 |
| | | ABB4 | 1.98 a y | 0.03 | 0.03 |
| | | CNF | 2.99 x | — | — |
| | 10 ppm | NC | 2.80 b | — | — |
| | | ABB1 | 4.57 a y | 0.03 | 0.31 |
| | | ABB2 | 3.65 b x | ns | ns |
| | | ABB3 | 3.28 b y | ns | 0.03 |
| | | ABB4 | 4.07 a x | 0.03 | ns |
| | | CNF | 3.91 x | — | — |

^{a}NC: negative control, sterile distilled water, ABB1: original algae isolate containing bacterial component (10\hat{ }7 algal cells + unknown quantity of bacterial cells), ABB2: algae isolate from lettuce root wash prepared from the preliminary inoculation test (10\hat{ }7 algal cells), ABB3: algae associated bacteria culture, contain two bacteria (ABB3_1 and ABB3_2, 10\hat{ }8 bacterial cells), ABB4: combination of ABB2 and ABB3 (10\hat{ }7 algal cells + 10\hat{ }8 bacterial cells), and CNF: chemical N fertilizer contains 20 ppm N started application at the same time of the inoculation and continued till the completion of the experiment
^{b}Pairwise comparisons between treatments and controls were performed using Mann-Whitney test. Different letters indicate significant differences (a, b: comparison with negative control (water) treatment, x, comparison with positive control (chemical N fertilizer treatment), P < 0.10).

A greenhouse trial was conducted to determine if the effects of the ABB4 inoculant would be reproduced under the more variable conditions of greenhouse production. The same growth matrix was used, and a titration of 0.5×, 1×, and 2× rates of the ABB4 was applied to wheat. Over the course of a six-week experiment, significant increases due to ABB4 were observed in shoot height and biomass (P<0.05), indicating that ABB4 can be effective under greenhouse production conditions. The plant response to the titration was not linear, indicating that the response could be saturated at higher levels of inoculum. This experiment was conducted under conditions of both nutrient and water stress, indicating that the ABB4 inoculant can further enhance plant growth under conditions of abiotic stress.

Following a field trial application of the ABB on winter wheat during the spring of 2011, an approximately 8% increase in the number of wheat heads per meter-row was observed. This indicates that applications to soil prior to tillering can increase yields in wheat. Additionally, reductions in the variance of plant height and head count across the plots was observed, indicating that applications of ABB may also reduce variability in wheat growth prior to harvest, an effect that facilitates more efficient harvesting.

Post-transplant application of ABB4 to tomatoes was also observed to increase plant height and shoot biomass prior to harvest in tomatoes. The observed mean increase in both tomato plant traits was approximately 10%. These data indicate that the responses of ABB4 in the growth chamber experiments predict positive field responses of different crops grown under field conditions.

Moreover, ABB4 has been dried into a flake with 10% to 15% moisture (wt for wt) and remained viable as an inoculant source for at least 10 weeks. These data indicate that ABB4 may be formulated as a dry flake formulation, for use as either bio-fertilizer production or source inoculum for on-farm production (in combination with an appropriate liquid growth medium).

### Other Embodiments

It is to be understood that while embodiments have been described in conjunction with the detailed description thereof, the foregoing description is intended to illustrate and not limit the scope of the invention. Other aspects, advantages, and modifications are within the scope of the following claims.

1. A growth enhancing composition for application to plants, comprising,
an algal component having a partial ITS gene sequence possessing at least 95% sequence identity to SEQ ID NO: 7; and
a bacterial component comprising an effective quantity of an isolated bacterium.

2. The composition according to claim 1, wherein the isolated bacterium is capable of living symbiotically with the algal component.

3. The composition of claim 1 wherein the algal component is from the family Chlamydomonas.

4. The composition of claim 1 wherein the algal component is from the family Dunaliellaceae.

5. The composition of claim 1 wherein the algal component is from the family Hematococcaceae.

6. The composition of claim 1, wherein the algal component comprises an effective quantity of an isolated algal strain deposited as ATCC accession number PTA-11477.

7. The composition of claim 6, wherein the bacterial component comprises bacterium having a partial 16S ribosomal RNA gene sequence possessing at least 97% sequence identity to SEQ ID NOS: 5 or 6.

8. The composition according to claim 7, wherein the isolated bacterium is selected from the group consisting of a first isolated Microbacterium strain deposited as ATCC accession number PTA-11476, a second isolated Microbacterium strain deposited as ATCC accession number PTA-11475, and a combination thereof.

9. The composition of claim 6 wherein the bacterial component comprises an isolated mutant bacterium having a partial 16S ribosomal RNA gene sequence possessing at least 97% sequence identity to SEQ ID NO: 5.

10. The composition of claim 6 wherein the bacterial component comprises an isolated mutant bacterium having a partial 16S ribosomal RNA gene sequence possessing at least 97% sequence identity to SEQ ID NO: 6.

11. The composition of claim 1, wherein the bacterial component comprises bacterium having a partial 16S ribosomal RNA gene sequence possessing at least 97% sequence identity to SEQ ID NOS: 5 or 6.

12. The composition of claim 11 wherein the bacterial component comprises an isolated bacterium from the genera Azospirillum.

13. The composition of claim 11 wherein the bacterial component comprises an isolated bacterium from the genera Azoarcus.

14. The composition of claim 11 wherein the bacterial component comprises an isolated bacterium from the genera Azorhizobium.

15. The composition of claim 11 wherein the bacterial component comprises an isolated bacterium from the genera Bradyrhizobiu.

16. The composition of claim 11 wherein the bacterial component comprises an isolated bacterium from the genera Rhizobium.

17. The composition of claim 11 wherein the bacterial component comprises an isolated bacterium from the genera Sinorhizobium.

18. The composition according to claim 11, wherein the isolated bacterium is selected from the group consisting of a first isolated Microbacterium strain deposited as ATCC accession number PTA-11476, a second isolated Microbacterium strain deposited as ATCC accession number PTA-11475, and a combination thereof.

19. The composition of claim 1, further comprising a carrier.

20. The composition of claim 1, wherein the carrier is selected from a solid and a liquid.

21. The composition of claim 1, wherein the carrier is a solid.

22. The composition of claim 1, wherein the carrier comprises a potting matrix.

23. A growth enhancing composition for application to plants, comprising,
an algal component comprising an isolated mutant of the algal strain deposited as ATCC accession number PTA-11477, the strain having a partial ITS gene sequence possessing at least 95% sequence identity to SEQ ID NO: 7; and
a bacterial component comprising an effective quantity of an isolated bacterium.

24. The composition of claim 23 wherein the bacterial component comprises an isolated mutant bacterium having a partial 16S ribosomal RNA gene sequence possessing at least 97% sequence identity to SEQ ID NO: 5.

25. The composition of claim 23 wherein the bacterial component comprises an isolated mutant bacterium having a partial 16S ribosomal RNA gene sequence possessing at least 97% sequence identity to SEQ ID NO: 6.

26. A plant contacted with the composition of claim 1.

27. The plant of claim 26, wherein the composition includes a carrier.

28. A seed coated with the growth enhancing composition according to any one of claim 1, 7, or 23.

29. A kit for increasing plant growth, comprising:
an algal component comprising an effective quantity of an isolated algal strain, the strain is deposited as ATCC accession number PTA-11477; and
a bacterial component comprising an effective quantity of an isolated bacterium; and
instructions for use of said algal and bacterial components for promoting plant growth.

30. The kit according to claim 29, wherein the isolated bacterium is capable of living symbiotically with the algal component.

31. The kit according to claim 29, wherein the isolated bacterium is selected from the group consisting of a first isolated Microbacterium strain deposited as ATCC accession number PTA-11476, a second isolated Microbacterium strain deposited as ATCC accession number PTA-11475, and a combination thereof.

32. The kit according to claim 29, wherein the algal component and the bacterial component are separately packaged.

33. A method for enhancing the growth of a plant, the method comprising the step of placing in the vicinity of the plant an effective quantity of an inoculant composition, the composition comprising:
an algal component comprising an effective quantity of an isolated algal strain deposited as ATCC accession number PTA-11477; and
a bacterial component comprising an effective quantity of an isolated bacterium.

34. The method according to claim 33, wherein the isolated bacterium is capable of living symbiotically with the algal component.

35. The method according to claim 33, wherein the isolated bacteria is selected from the group consisting of a first isolated Microbacterium strain deposited as ATCC accession number PTA-11476, a second isolated Microbacterium strain deposited as ATCC accession number PTA-11475, and a combination thereof.

36. The method according to claim 33, wherein the effective quantity of the algal strain comprises greater than about 1×10⁴ algal cells per ml or per g carrier or per seed and the effective quantity of the isolated bacteria comprises greater than about 1×10⁵ bacterial cells per ml or per g carrier or per seed.

37. The method according to claim 33, wherein the bacterium comprises the first isolated Microbacterium strain deposited as ATCC accession number PTA-11476.

38. The method according to claim 33, wherein the bacterium comprises the second isolated Microbacterium strain deposited as ATCC accession number PTA-11475.

39. The method according to claim 33, wherein the plant is selected from the group consisting of green beans, turf grasses, sweet potato, tomatoes, cotton, corn, soy beans, okra, lettuce, tomato, squash, vegetables, tea, wheat, barley, rice, and canola.

40. The method according to claim 33, wherein the inoculant composition is applied before or during planting.

41. The method according to claim 33, wherein the composition is applied as a seed coating.

42. A method for increasing plant growth, comprising: inoculating a plant with plant growth promoting mixture, the mixture comprising,
an algal component having a partial ITS gene sequence possessing at least 95% sequence identity to SEQ ID NO: 7; and
a bacterial component comprising an effective quantity of an isolated bacterium, the bacterium having a partial 16S ribosomal RNA gene sequence possessing at least 97% sequence identity to SEQ ID NOS: 5 or 6.

43. A method for increasing plant growth, comprising: inoculating a plant with plant growth promoting mixture, the mixture comprising,
an algal component having a partial ITS gene sequence possessing at least 95% sequence identity to SEQ ID NO: 7; and
a bacterial component comprising an effective quantity of an isolated bacterium capable of living symbiotically with the algal component.


SEQUENCE LISTING (7 sequences)

SEQ ID NO: 1 - DNA, 20 bp, Artificial Sequence
  Primer
agagtttgatcctggctcag

SEQ ID NO: 2 - DNA, 21 bp, Artificial Sequence
  Primer
acggctaccttgttacgactt

SEQ ID NO: 3 - DNA, 22 bp, Artificial Sequence
  Primer
ggaagtaaaagtcgtaacaagg

SEQ ID NO: 4 - DNA, 20 bp, Artificial Sequence
  primer
tcctccgcttattgatatgc

SEQ ID NO: 5 - DNA, 760 bp, Unknown
  Microbacterium species
aagccagcttgcttggtggatagtggcgaacgggtgagtaacacgtgagcaacctgccctggactctgggataagcgctggaaacggcgtctaatactggatatgagctctcatcgcatggtgggggttggaaagattttttggtctgggatgggctcgcggcctatcagcttgttggtgaggtaatggctcaccaaggcgtcgacgggtagccggcctgagagggtgaccggccacactgggactgagacacggcccagactcctacgggaggcagcagtggggaatattgcacaatgggcggaagcctgatgcagcaacgccgcgtgagggatgacggccttcgggttgtaaacctcttttagcagggaagaagcgaaagtgacggtacctgcagaaaaagcgccggctaactacgtgccagcagccgcggtaatacgtagggcgcaagcgttatccggaattattgggcgtaaagagctcgtaggcggtttgtcgcgtctgctgtgaaatcccgaggctcaacctcgggcctgcagtgggtacgggcagactagagtgcggtaggggagattggaattcctggtgtagcggtggaatgcgcagatatcaggaggaacaccgatggcgaaggcagatctctgggccgtaactgacgctgaggagcgaaagggtggggagcaaacaggcttagataccctggtagtccaccccgtaaacgttgggaactagttgtggggaccattccacggtttccgtg

SEQ ID NO: 6 - DNA, 720 bp, Microbacterium hominis
gctgggtggatcagtggcgaacgggtgagtaacacgtgagcaatctgcccctgactctgggataagcgctggaaacggcgtctaatactggatacgagctgcgatcgcatggtcagtagctggaaagattttttggtcagggatgagctcgcggcctatcagcttgttggtgaggtaatggctcaccaaggcgtcgacgggtagccggcctgagagggtgaccggccacactgggaccgagacacggcccagactcctacgggaggcagcagtggggaatattgcacaatgggcgcaagcctgatgcagcaacgccgcgtgagggatgacggccttcgggttgtaaacctcttttagcagggaagaagcgaaagtgacggtacctgcagaaaaagcgccggctaactacgtgccagcagccgcggtaatacgtagggcgcaagcgttatccggaattattgggcgtaaagagctcgtaggcggtttgtcgcgtctgctgtgaaatcccgaggctcaacctcgggtctgcagtgggtacgggcagactagagtgcggtaggggagattggaattcctggtgtagcggtggaatgcgcagatatcaggaggaacaccgatggcgaaggcagatctctgggccgtaactgacgctgaggagcgaaagggtggggagcaaacaggcttagataccctggtagtccaccccgtaaacgttgggaa

SEQ ID NO: 7 - DNA, 660 bp, Unknown
  Algae Chlamydomonadales deposited as ATCC Accession No. PTA - 11477
tgtgaacctcttactgtcggtccgctgggacgaattaacttccgccccggtgcagtccgggccatgttcattggttcggattgggttcgcccacacaacatctttacggtgctgtgtgaagcgcgctggcccctatcaaaacaaaccatattaacaccaaaccaaaacctttcttgaatcttactaaatgcggtaggcccggcctctgcatctaactaagacaactctcaacaacggatatcttggctctcgcaacgatgaagaacgcagcgaaatgcgatacgtagtgtgaattgcagaattccgtgaaccatcgaatctttgaacgcatattgcggtcgaggcttctgccgagaccatgtctgcctcagcgtcgggtttatatcactccctatataccttgtgtatataatcaagagtggacctggccgttccagctaggccctgctttcgaaagaaggcaaccaggctctggatcggctgaagatcagagttctgaccgaggacccttcaagggccgcaactgggtgggcatttccaatgctaagctttagttgttggcctgggatttcggttgtcgacctcaaacaggaaacccacaacttattatattctcgacctgagctcaggcaagaacacccgctgaacttaagcatatca